(19) United States
(12) Patent Application Publication
(10) Pub. No.: US 2005/0064151 A1
(43) Pub. Date: Mar. 24, 2005

(54) Ink jet printable security document

(76) Inventors: Rajendra Mehta, Dayton, OH (US); Sean M. Hastings, Braintree, MA (US); David E. Washburn, Kettering, OH (US)

Correspondence Address: DINSMORE & SHOHL LLP, Suite 500, One Dayton Centre, Dayton, OH, 45402-2023, US

(21) Appl. No.: 10/666,915

(22) Filed: Sep. 18, 2003

(51) Int. Cl. B32B 3/00

(52) U.S. Cl. 428/195.1

(57) ABSTRACT

A security document including layers of security coatings disposed on a substrate. The coating layers include a first security coating disposed on the substrate and a second security coating disposed on the first security coating. One of the security coatings is a solvent-sensitive coating, while the other is an abrasion-sensitive coating. Together, these coatings ensure that attempts at tampering with the document produce notorious indicia of such tampering. The security document is particularly adapted for ink jet printing. Additional security features may include thermochromic ink, bar codes, and pantographic warnings, as well as another solvent-sensitive security coating that is distinct from the earlier-described solvent-sensitive coating. By way of example, this second solvent-sensitive coating could be configured to be sensitive to particular forms of tampering, such as where solutions containing phosphoric acid are used to tamper with the document.

### BACKGROUND OF THE INVENTION

The present invention is directed generally to a security document, and in particular to a security document that can accept indicia printed thereon from a suitable printing process such that the printed indicia is sensitive to multiple modes of tampering, including attacks based on the application of heat, abrasion or solvents.

The use of security enhancements integrated into documents is well known. Examples include currency, checks and related negotiable instruments, as well as personnel identification devices, such as birth certificates, social security cards and driver's licenses, the latter of which are frequent targets of tampering because of their pervasive use as prima facie evidence of age, residency or the like. The ascendancy of high-speed non-impact printing devices to print large quantities of such documents has been in part due to their relative low cost and quiet, reliable operation. Ink jet printers are one form of non-impact printing, where highly atomized ink is sprayed onto a document surface. Printed indicia placed on the surface of a document from an ink jet printer forms a relatively clear, durable bond with the underlying document substrate. It would be additionally advantageous to maintain the conveniences of non-impact printing while simultaneously providing enhanced added security features. As such, there is a need for providing added security features through discrete coatings placed on documents formed by ink jet and related non-impact printing methods.

### SUMMARY OF THE INVENTION

These needs are met by the present invention, which is directed to an anti-counterfeit, tamper-resistant security document. According to one aspect of the present invention, a security document includes a substrate, a first security coating disposed on the substrate, and a second security coating disposed on the first security coating. One of the security coatings is a solvent-sensitive coating and the other of the security coatings is an abrasion-sensitive coating. By this construction, attempts at tampering with the document produce notorious indicia of such tampering on the document. In one form the notorious indicia of tampering comprises a predetermined pattern, such as warning phrase spelling out words such as “void” or the like. The substrate may be made up of a tear-resistant laminate where, for example, a layer of film is coupled to a layer of paper, or a layer of film is sandwiched between a pair of paper layers, in either case such that the film gives the laminate its toughness, while the paper makes it easy for the document to accept printed indicia from an automated printing device. While the present invention is preferably configured for use with ink jet printers, it will be appreciated by those skilled in the art that use with other non-impact printers, such as thermal transfer printers, is also contemplated, and therefore deemed to be within the scope of the present invention.

Optionally, a third security coating can be disposed adjacent one of the first or second security coatings. This third security coating can provide supplemental solvent protection to the document. For example, the third security coating could generally be a tinted water-based flexographic ink, and more particularly a flexographic ink made up of approximately ten to forty percent liquid dye, ten to ninety percent water-soluble binder, and up to one percent surface additive. In the present context, the use of the term “approximately” is meant to modify both the upper and lower ranges of each of the respective ingredients, not just the immediately following range. The third security coating can be configured to be sensitive to at least a solution containing phosphoric acid. This could be especially valuable in situations where the other solvent-sensitive coating is not tailored to respond to such a solution. In one form, the first security coating is a solvent-sensitive coating. This coating can also be configured to activate (or respond) to the application of an elevated temperature to the document. In another option, an authentication zone can be placed on the document to allow easy verification of the document's authenticity. In one form, the authentication zone can include a thermochromic ink disposed either in or adjacent to one of the document's security coatings or the substrate. In one particular configuration, the thermochromic ink comprises an uppermost layer of the document.

The document itself may include a folding region to allow the document to assume a substantially coextensive two-layer configuration when the document is folded along the folding region. As used in conjunction with the present disclosure, the term “substantially” refers to an arrangement of elements or features that, while in theory would be expected to exhibit exact correspondence or behavior, may, in practice embody something slightly less than exact. Thus, the two layers (or flaps) of the folded-over document are intended to be coextensive, but due to margins within a given folding process, may not be perfectly so. To facilitate accurate folding, the folding region may include a fold line printed on or formed in the document. The document can also include a printable surface, where such surface can coincide substantially with one of the security coatings. Preferably, the printed indicia is in the form of ink jet printing. The surface of the document (either on the surface of the substrate or one or both of the security coatings) can include additional security indicia, an example of which can be disposed on an opposite surface of the substrate from the first and second security coatings. This additional security indicia can be copy-evident indicia such as that taught in U.S. Pat. Nos. 5,197,765 and 5,340,159, both of which are owned by the Assignee of the present invention and hereby incorporated by reference, a bar code or other related indicia. Other forms of security features that may be incorporated include laid lines, microprinting, photochromic inks, fluorescent fibers and inks, optical variable inks (OVI), secure fonts or the like. One form of the document can be a driver's permit where, in the present context, a driver's permit can cover both temporary and permanent licenses, as well as commercial and private licenses. In one preferred form, the document is a temporary driver's license. The document can also form a separable portion along at least one line of weakness, where the line of weakness preferably (but not necessarily) comprises a full die cut or a perforated die cut. In one example, the separable portion can be a driver's permit that can be removed from a larger form such that after the driver's permit is separated, the form may be discarded or (if inclusive of transactional or related data) saved as a receipt or the like. In another option, the substrate can be configured as either a cut sheet or a continuous roll or flat pack. In other options, the first and second security coatings each form a discrete layer adjacent to one another. Moreover, the abrasion-sensitive coating is pervious to solvents that would activate the solvent-sensitive coating, thus allowing the solvents to pass through to the solvent-sensitive layer disposed below.

According to another aspect of the invention, a security document includes a tear-resistant laminate substrate, a solvent-sensitive coating disposed on the substrate, an abrasion-sensitive coating disposed on the solvent-sensitive coating, and additional security indicia disposed on at least one surface of the substrate such that attempts at tampering with the document produce notorious indicia of such tampering. The abrasion-sensitive coating is configured to receive printed indicia. One form of tampering that the security document inhibits is copying, especially photocopying. Upon such copying, a warning message (that was, for example, previously latent) is reproduced on the copied document. The substrate can include opposing top and bottom surfaces, where the solvent-sensitive coating is disposed on the top surface. In one form, the additional security indicia is placed on the bottom surface. The additional security indicia may be thermochromic ink, bar codes or pantographs, although it will be appreciated that other known security indicia may also be used. While the tear-resistant laminate may be any configuration with which to toughen the substrate, it preferably comprises a layer of film sandwiched between a pair of paper layers. In another form, the additional security indicia can be made from an additional solvent-sensitive coating. This coating is preferably disposed on the abrasion-sensitive coating, and may be the same or different than the solvent-sensitive coating disposed against the substrate.

According to still another aspect of the present invention, a driver's permit includes a tear-resistant laminate substrate, a solvent-sensitive coating disposed on the substrate, an abrasion-sensitive coating disposed on the solvent-sensitive coating, and printed indicia disposed over the abrasion-sensitive coating, the printed indicia comprising fixed text, variable text and a picture. In the present context, the requirement that the printed indicia be disposed “over” the abrasion-sensitive coating is not to be construed to limit them to being in contact with one another, but merely that the former be placed somewhere above the latter on the substrate. Thus, static printed indicia, such as press printing, may be above or below any of the tamper evident coatings. Optionally, the driver's permit further includes additional security indicia disposed on at least one surface of the substrate. This construction thwarts attempts at tampering with the document by producing notorious indicia upon such tampering. As with at least one of the previous aspects, the driver's permit is preferably a temporary driver's license. Also as previously discussed in conjunction with at least one of the prior aspects, the additional security indicia is preferably a thermochromic ink, bar code, pantograph or additional solvent-sensitive coating. In still other options, the substrate includes a folding region, and a separable portion along at least one line of weakness, both as previously discussed.

According to yet another aspect of the present invention, a method of making a security document includes the steps of preparing a substrate to accept a plurality of security coatings, configuring a first security coating and a second security coating such that one is a solvent-sensitive coating and the other is an abrasion-sensitive coating. As with the previously discussed aspects, attempts at tampering with the document activate at least one of the security coatings to produce notorious indicia of such tampering on the document. Additional steps include depositing the first security coating on the substrate and the second security coating on the first security coating. Optionally, the step of configuring the substrate includes configuring a tear-resistant laminate similar to those previously discussed, where, by way of example, the tear-resistant laminate can be made from a layer of film sandwiched between a pair of paper layers. Another optional step can include printing indicia on the security document, where the printed indicia can be one or more of fixed text, variable text or a picture. As with the earlier-described aspects, the document can be configured as a driver's permit. Also as before, additional security indicia may be placed on the document, including (but not limited to) thermochromic ink, bar codes or pantographs. It will be appreciated that one or more of these may be combined, depending on the need. The additional security indicia can also be an additional solvent-sensitive coating configured to be disposed on the abrasion-sensitive coating. Another optional step could be configuring the additional solvent-sensitive coating to be sensitive to at least a solution containing phosphoric acid, also as previously discussed.

### BRIEF DESCRIPTION OF THE DRAWINGS

FIG. 1 is a view of a security document with two panels according to an embodiment of the present invention;

FIG. 2 is a view of a single-panel variant of the security document of FIG. 1;

FIG. 3 is a view showing the various layers making up the security document of FIG. 1;

FIG. 4 is view showing the embodiment of FIG. 3 with an additional security coating deposited thereon;

FIG. 5 shows a security document similar to that of FIG. 1 with additional detail; and

FIG. 6 shows copy-evident indicia that can be disposed on one or both sides of the security document.

### DETAILED DESCRIPTION OF THE PREFERRED EMBODIMENTS

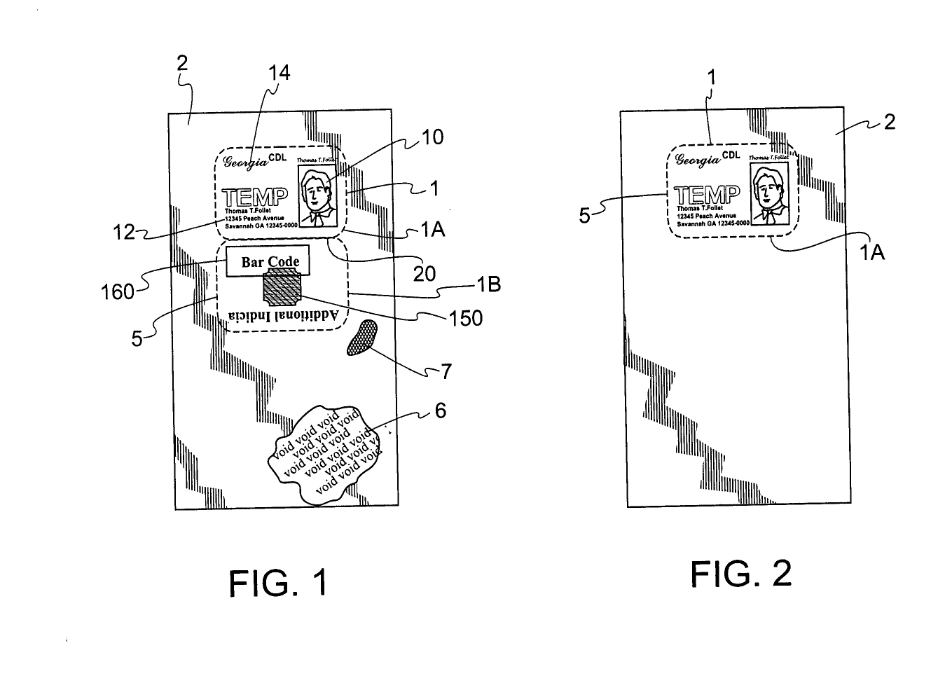

Referring first to FIGS. 1 and 2, a security document 1 is shown as part of a larger form 2. Security document 1 can be an integral part of form 2 and separable therefrom along one or more lines of weakness 5. The lines of weakness 5 can be made from a perforated die cut (as shown) or a full die cut. In other configurations, the security document 1 may be a separate card affixed to form 2, either nested in a window of the form 2 or on top of the form 2. The security document 1 as shown is in the form of a temporary driver's license, although it will be appreciated that the features giving the temporary driver's license its security attributes may be employed on any type of security document 1. The temporary driver's license includes picture (or image) 10, variable text 12 (such as individualized information, including name, signature, address, personal statistics or the like) and fixed text 14 (such as the issuing authority). While the information corresponding to the images 10 and variable and fixed text 12, 14 can be produced by any non-impact printer, including laser printers, ink jet printers, and thermal transfer printers, the preferred approach involves the use of ink jet printers. The form 2 may be a discrete cut sheet (as shown) such that it can fit into the tray of a suitable printer device, or be part of a larger continuous roll or flat pack (neither of which are shown). Form 2 can be configured such that it defines a single-panel 1A on security document 1 (as shown with particularity in FIG. 2), or two panels 1A, 1B as shown in FIG. 1. In this latter configuration, a folding region 20 can be formed between adjacent panels 1A, 1B to indicate to a user where the security document 1 should be folded. The folding region 20 may be marked (such as with a generally horizontal line across some or all of form 2), or could be formed from a perforation or crease. A foldable version of the security document 1 is advantageous in that it allows, upon substantially coextensive folding of the two panels 1A, 1B over each other, a two-sided document 1 can be formed while preserving simplex (i.e., one-sided) printing. With the two-sided version, the two panels 1A, 1B can be folded inward to protect the images 10 and text 12, 14 from scuffs, spills or the like. Alternately, the two-sided version may be folded outward with the two panels 1A, 1B bonded together with adhesive. In either the two-sided version of FIG. 1 or the one-sided version of FIG. 2, the size and ease of removability facilitate high rates of document production, and are amenable to other procedures, such as subsequent lamination.

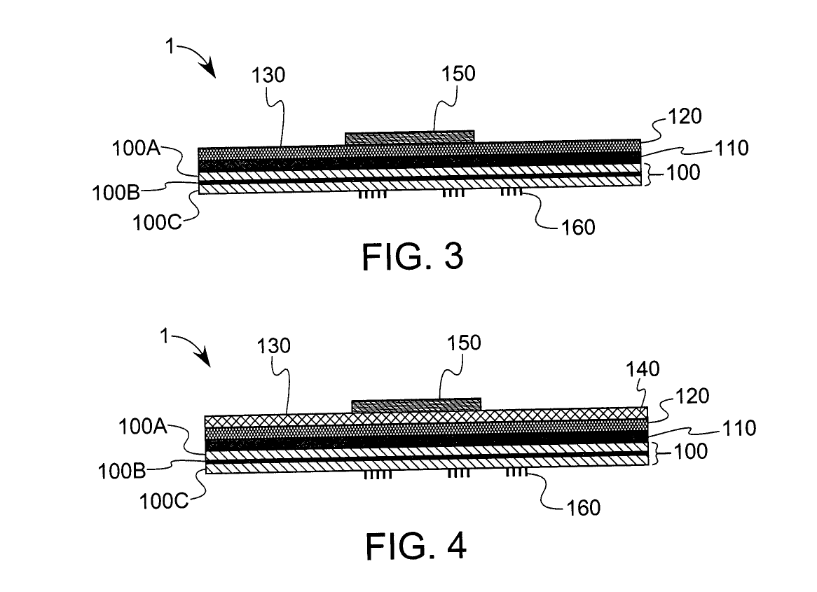

Some of the security features of the present invention are made possible by the application of a plurality of coatings placed on the surface of the document 1. These coatings (which will be described below in conjunction with FIGS. 3 and 4 below) are sensitive to various attempted forms of document tampering, providing notorious indicia 6, 7 of such tampering. For example, notorious indicia 6 shows an area on the surface of form 2 where an attempt at alteration of the document 1 involved rubbing a solvent on the images or text. Likewise, notorious indicia 7, shows an area abraded by an eraser or similar pressure-producing instrument such that abrasion-sensitive features in one of the coatings produce the notorious indicia 7. It will be appreciated that the locations where notorious indicia 6, 7 show up in FIG. 1 are for illustrative purposes only, and that the security features discussed in conjunction with the present invention could be applied to any or all parts of form 2, specifically to the areas defined by the security document 1. Other security-enhancing features can also be employed, such as thermochromic ink spots 150 and other security indicia 160 (such as the aforementioned bar codes, pantographs, laid lines, microprinting, photochromic inks, fluorescent fibers and inks, OVI, secure fonts or the like), both of which will be described in more detail below.

Referring next to FIGS. 3 and 4, the security document 1 construction includes numerous layers of security coatings 110, 120 and 140 deposited onto a printable surface substrate 100.

The top surface 130 of the security document 1 is ink jet printable such that digitally printed photographs and computer-generated text may be placed thereon. The substrate 100 is preferably tear-resistant, made from (by way of example) a paper/film/paper laminate comprising layers 100A, 100B and 100C, respectively. An example of a suitable substrate 100 is TRU-TECH® 7.3 mil Uncoated Cover from Tru-Tech Fine Papers, Inc. of Harrison, N.Y. The presence of a paper-based upper layer 100A permits easy printing from an ink jet printer, although it will be appreciated that other print-receptive upper layers (including plastic) could also be used, especially in situations where the substrate is specifically designed for ink jet printers, or if a solvent-based ink jet ink was used. Similarly, the three-layer configuration of substrate 100 depicted herein is not critical; other configurations (including other laminate configurations) could also be employed to provide enhanced tear-resistance.

The coating layers giving enhanced security include an abrasion-sensitive top coating 120 that defines the top surface 130 and provides indicia (such as by changing color, etc) when abraded by erasers, knives, fingernails or related pressure-producing instruments. Preferably, abrasion-sensitive coating 120 undergoes a color change when abraded. Although shown notionally in the figure as covering the entire upper surface of the coating immediately beneath it, it will be appreciated that abrasion-sensitive coating 120 can also be deposited in a pattern to produce a hidden message. In one preferable form, abrasion-sensitive coating 120 is self-contained such that all of the components necessary to produce the security indicia are integrated into the coating itself, rather than relying on a separate coating layer. Such self-contained coatings may include a dye precursor or chromogen (such as a leuco dye) and a color developer acting as an activating agent for the dye precursor. Either (or both) of the color former or color developer may be in capsule form. In addition, the coating may include a sensitizer to increase the sensitivity of the encapsulated agents to abrasion forces. An example of a suitable abrasion-sensitive coating may be found in U.S. Pat. No. 5,102,856, owned by the Assignee of the present invention and hereby incorporated by reference, although it will be appreciated that others may be used. The abrasion-sensitive coating 120 is porous to solvents. Thus, if solvents are used in an attempt to defeat the security features of document 1, the solvent will pass through the abrasion-sensitive coating 120 to activate a solvent-sensitive coating 110 disposed underneath.

Solvent-sensitive coating 110, upon activation by a solvent, either reveals hidden words (such as “void” or the like) or causes the dispersal of a dye that provides notorious indicia that the document's visual attributes have been corrupted. In addition, solvent-sensitive coating 110 can be configured to activate upon application of an elevated temperature. By way of example, the application of a temperature in the range of 150° F. or more can cause solvents and dyes in the coating 110 to interact, thereby forming a predetermined warning or related indicator. An example of a suitable solvent-sensitive coating may be found in U.S. Pat. No. 5,209,515, owned by the Assignee of the present invention and hereby incorporated by reference, although it will be appreciated that others may be used. As with the abrasion-sensitive coating 120 discussed above, it will be appreciated that solvent-sensitive coating 110 can also be deposited in a pattern to produce hidden words or related messages.

Referring with particularity to FIG. 4, a third layer of security coating 140 can be deposited over the top surface 130 defined by the abrasion-sensitive coating 120. Security coating 140 protects ink jet printed images from specific types of solvent attack that the solvent-sensitive coating 110 and the abrasion-sensitive coating 120 might not be sufficiently effective against. In one specific form of attack, frozen cubes of commercially-available cola beverages are rubbed over the image to alter or remove portions thereof. It has been hypothesized that the effectiveness of a cola-based attack is due to the presence of phosphoric acid in the beverage.

Security coating 140 is preferably made from a tinted water-based flexographic ink. In one form, the ink comprises approximately ten to forty percent liquid dye, approximately ten to ninety percent water-soluble binder, and up to approximately one percent surface additive, the last for surface tension reduction. In this formulation, the liquid dye is a combination of three liquid dyes (such as red, yellow and blue) to produce a gray tint. With such coatings, a light tint is present in the coating. Upon attempted alteration of document 1 by the aforementioned beverage (or related solvent), a hazy-appearing halo forms.

Additional security features, such as an authentication zone in the form of thermochromic ink 150, bar codes (not presently shown), repeating patterns (such as a “void” pantograph) or related security indicia 160 can all be optionally included to provide additional security. It will be appreciated by those skilled in the art that the thermochromic ink 150, and security indicia 160 could be placed on other surfaces of the security document 1, and in some cases can be placed between the substrate 100 and the various coatings 110, 120 and 140, or between the coatings themselves. Thermochromic ink 150 is responsive to heat (such as due to human touch), and can change from color to colorless (or color to color) upon the application of heat, and upon removal of the heat, return to their unheated color. An example of a suitable thermochromic ink may be found in U.S. Pat. No. 6,413,305, owned by the Assignee of the present invention and hereby incorporated by reference, although it will be appreciated that others may be used. As with the abrasion-sensitive coating 120, the underlying message could be repeating words or the like. In one particular example, thermochromic ink 150 can be in the form of a State Seal.

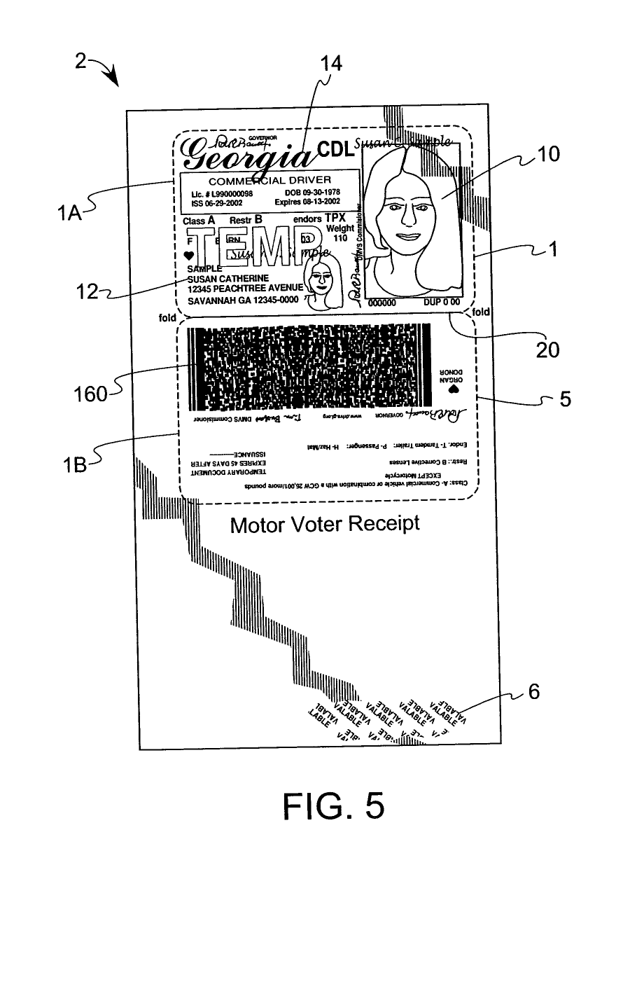

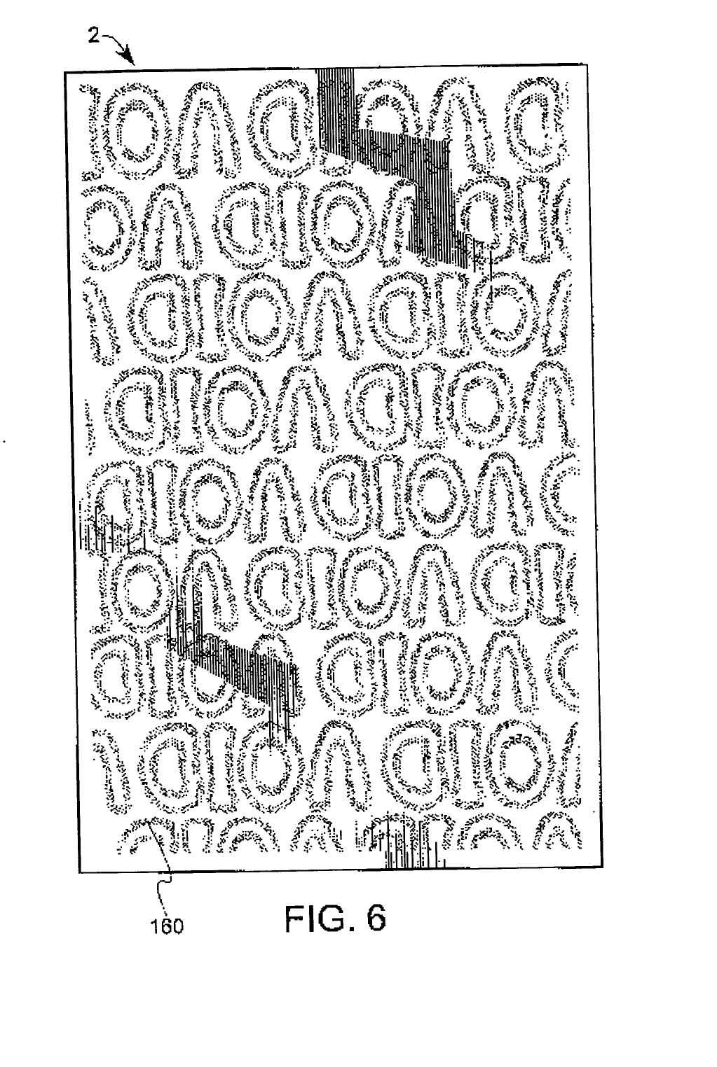

Referring next to FIGS. 5 and 6, details relating to security features incorporated into security document 1 are shown embodied as a temporary driver's license. As with FIG. 1, security document 1 includes two panels 1A, 1B as part of form 2, from which it can be along lines of weakness 5. Picture 10 and variable text 12 convey information specific to the driver. Fixed text 14 may convey information related to the issuing authority. Folding region 20 permits the document 1 to be simplex printed and folded over to form a multilayer license. By being included as part of form 2, a blank of the security document 1 may be placed in a cut sheet tray of a simplex printing device (not shown), such that upon entry of appropriate driver and related information into automated data processing equipment (not shown), the license can be printed, separated and folded in a very short time period while retaining all of the security features built in to the document 1. Referring with particularity to FIG. 6, the bottom surface of form 2 is shown, where security indicia 160 in the form of a “void” pantograph is shown to demonstrate that such indicia may be in the form of a patterned coating, ink or the like. In the “void” pantograph form shown, the entire bottom surface of form 2 (of which security document 1 defines a part) appears, giving someone viewing form 2 a readily apparent indication that the document being viewed is a photocopy. It will be appreciated that the “void” pantograph is shown as a representative rather than exclusive use of additional security indicia 160, and further that such techniques can be used on either surface of substrate 100, as well as (in some instances) between substrate 100 and one or more of the layers of security coatings 110, 120 and 140.

Having described the invention in detail and by reference to preferred embodiments thereof, it will be apparent that modifications and variations are possible without departing from the scope of the invention defined in the appended claims.

1. A security document comprising:
a substrate;
a first security coating disposed on said substrate; and
a second security coating disposed on said first security coating, wherein one of said security coatings is a solvent-sensitive coating and another of said security coatings is an abrasion-sensitive coating such that attempts at tampering with said document produce notorious indicia of such tampering on said document.

2. The document of claim 1, wherein said notorious indicia of tampering comprises a predetermined pattern.

3. The document of claim 2, wherein said predetermined pattern comprises a warning phrase.

4. The document of claim 1, wherein said substrate comprises a tear-resistant laminate.

5. The document of claim 4, wherein said tear-resistant laminate comprises a layer of film sandwiched between a pair of paper layers.

6. The document of claim 1, further comprising a third security coating disposed adjacent one of said first or second security coatings, said third security coating configured to provide supplemental solvent protection.

7. The document of claim 6, wherein said third security coating comprises a tinted water-based flexographic ink.

8. The document of claim 7, wherein said water-based flexographic ink comprises approximately ten to forty percent liquid dye, approximately ten to ninety percent water-soluble binder, and up to approximately one percent surface additive.

9. The document of claim 6, wherein said third security coating is configured to be sensitive to at least a solution containing phosphoric acid.

10. The document of claim 1, wherein said first security coating is a solvent-sensitive coating.

11. The document of claim 10, wherein said solvent-sensitive coating is also configured to activate upon the application of an elevated temperature to said document.

12. The document of claim 1, further comprising additional security indicia disposed either in or adjacent one of said security coatings or said substrate.

13. The document of claim 12, wherein said additional security indicia comprises thermochromic ink.

14. The document of claim 13, wherein said thermochromic ink comprises an uppermost layer of said document.

15. The document of claim 12, wherein said additional security indicia is selected from the group consisting of laid lines, microprinting, photochromic inks, fluorescent fibers, fluorescent inks, optical variable inks, bar codes, pantographs and secure fonts.

16. The document of claim 1, further comprising a folding region on said substrate such that upon folding said document along a portion thereof that defines said folding region, said document assumes a substantially coextensive two-layer configuration.

17. The document of claim 16, wherein said document comprises a fold line printed on or formed in said document to define said folding region.

18. The document of claim 1, wherein a printable surface defined substantially by one of said security coatings is configured to accept printed indicia thereon.

19. The document of claim 18, wherein said printed indicia is in the form of ink jet printing.

20. The document of claim 18, wherein said printed indicia is in the form of thermal transfer printing.

21. The document of claim 1, further comprising additional security indicia disposed on an opposite surface of said substrate from said first and second security coatings.

22. The document of claim 21, wherein said additional security indicia comprises copy-evident indicia.

23. The document of claim 21, wherein said additional security indicia comprises a bar code.

24. The document of claim 1, wherein said document is a driver's permit.

25. The document of claim 24, wherein said driving permit is a temporary driver's license.

26. The document of claim 1, wherein said document forms a separable portion along at least one line of weakness.

27. The document of claim 26, wherein said at least one line of weakness comprises a full die cut.

28. The document of claim 26, wherein said at least one line of weakness comprises a perforated die cut.

29. The document of claim 1, wherein said substrate comprises a cut sheet.

30. The document of claim 1, wherein said substrate comprises a continuous roll or flat pack.

31. The document of claim 1, wherein said first and second security coatings each form a discrete layer adjacent to one another.

32. The document of claim 1, wherein said abrasion-sensitive coating is pervious to solvents that would activate said solvent-sensitive coating.

33. A security document comprising:
a tear-resistant laminate substrate;
a solvent-sensitive coating disposed on said substrate;
an abrasion-sensitive coating disposed on said solvent-sensitive coating, said abrasion-sensitive coating configured to receive printed indicia thereon; and
additional security indicia disposed on at least one surface of said substrate such that attempts at tampering with said document produce notorious indicia of such tampering.

34. The document of claim 33, wherein said attempt at tampering comprises copying, such that upon such copying, said notorious indicia of tampering comprises a warning message on a reproduced document produced by said copying.

35. The document of claim 33, wherein said substrate defines a top surface upon which said solvent-sensitive coating is disposed and a bottom surface opposite said top surface.

36. The document of claim 35, wherein said additional security indicia disposed on said bottom surface.

37. The document of claim 36, wherein said additional security indicia is selected from the group consisting of thermochromic ink, bar codes, pantographs, laid lines, microprinting, photochromic inks, fluorescent fibers, fluorescent inks, optical variable inks and secure fonts.

38. The document of claim 35, wherein said additional security indicia disposed on said top surface.

39. The document of claim 38, wherein said additional security indicia is selected from the group consisting of thermochromic ink, bar codes, pantographs, laid lines, microprinting, photochromic inks, fluorescent fibers, fluorescent inks, optical variable inks and secure fonts.

40. The document of claim 33, wherein said tear-resistant laminate comprises a layer of film sandwiched between a pair of paper layers.

41. The document of claim 33, wherein said additional security indicia comprises an additional solvent-sensitive coating, said additional solvent-sensitive coating disposed on said abrasion-sensitive coating.

42. The document of claim 41, wherein the composition of said additional solvent-sensitive coating is different than said solvent-sensitive coating disposed against said substrate.

43. A driver's permit comprising:
a tear-resistant laminate substrate;
a solvent-sensitive coating disposed on said substrate;
an abrasion-sensitive coating disposed on said solvent-sensitive coating; and
printed indicia disposed over said abrasion-sensitive coating, said printed indicia comprising fixed text, variable text and a picture.

44. The driver's permit of claim 43, further comprising additional security indicia disposed on at least one surface of said substrate such that attempts at tampering with said document produce notorious indicia of such tampering.

45. The driver's permit of claim 43, wherein said driver's permit is a temporary driver's license.

46. The driver's permit of claim 44, wherein said additional security indicia is selected from the group consisting of thermochromic ink, bar codes, pantographs, laid lines, microprinting, photochromic inks, fluorescent fibers, fluorescent inks, optical variable inks, secure fonts and additional solvent-sensitive coatings

47. The driver's permit of claim 44, wherein said substrate comprises a folding region therein such that upon folding said driver's permit along said folding region, said driver's permit assumes a substantially coextensive two-layer configuration where said printed indicia is disposed on both layers of said two-layer configuration.

48. The driver's permit of claim 44, wherein said substrate forms a separable portion along at least one line of weakness.

49. The driver's permit of claim 48, wherein said at least one line of weakness comprises a perforated die cut.

50. A method of making a security document, said method comprising:
preparing a substrate to accept a plurality of security coatings thereon;
configuring a first security coating and a second security coating such that one of said security coatings is a solvent-sensitive coating and another of said security coatings is an abrasion-sensitive coating whereby attempts at tampering with said document activate at least one of said security coatings to produce notorious indicia of such tampering on said document;
depositing said first security coating on said substrate; and
depositing said second security coating on said first security coating.

51. The method of claim 50, wherein said step of configuring said substrate comprises configuring a tear-resistant laminate.

52. The method of claim 51, wherein said tear-resistant laminate comprises a layer of film sandwiched between a pair of paper layers.

53. The method of claim 52, comprising the additional step of printing indicia on said security document.

54. The method of claim 53, wherein said printed indicia comprises comprising fixed text, variable text and a picture.

55. The method of claim 52, wherein said document is configured as a driver's permit.

56. The method of claim 52, comprising the additional step of depositing additional security indicia on said document.

57. The method of claim 56, wherein said additional security indicia is selected from the group consisting of thermochromic ink, bar codes and pantographs.

58. The method of claim 56, wherein said additional security indicia comprises an additional solvent-sensitive coating configured to be disposed on said abrasion-sensitive coating.

59. The method of claim 58, comprising the additional step of configuring said additional solvent-sensitive coating to be sensitive to at least a solution containing phosphoric acid.
